(19) United States
(12) Patent Application Publication
(10) Pub. No.: US 2005/0141430 A1
(43) Pub. Date: Jun. 30, 2005

(54) Monitoring network information

(76) Inventor: Nancy S. Borkowski, Lunenberg, MA (US)

Correspondence Address: FISH & RICHARDSON, PC, 12390 EL CAMINO REAL, SAN DIEGO, CA, 92130-2081, US

(21) Appl. No.: 10/749,926

(22) Filed: Dec. 30, 2003

(51) Int. Cl. H04L 12/26

(52) U.S. Cl. 370/241; 370/359

(57) ABSTRACT

A method includes monitoring a bit in a coprocessor included in a packet engine that represents an operation associated with a packet processor that includes the packet engine, and providing the packet engine the status of the bit.

### BACKGROUND

Networks are used to distribute information among computer systems by sending the information in segments such as packets. To connect to such networks with computer systems located in homes and small businesses, some residences and business owners subscribe through a local telephone company to receive a digital subscriber line (DSL) that provides a high-bandwidth network connection over ordinary copper telephone lines. By monitoring customer DSL connections, the telephone company can determine when a particular subscriber's computer system is ready for servicing.

### DESCRIPTION OF DRAWINGS

FIG. 1 is a block diagram depicting a system for transmitting packets.

FIG. 2 is a block diagram depicting a network processor.

FIG. 3 is a block diagram depicting portions of a network processor engine.

FIGS. 4A-B are block diagrams depicting an index variable, an indicator, a status word, and a mask used by a network processor engine.

FIG. 5 is a flow chart of a portion of a line monitor.

FIG. 6 is a flow chart of another portion of a line monitor.

### DESCRIPTION

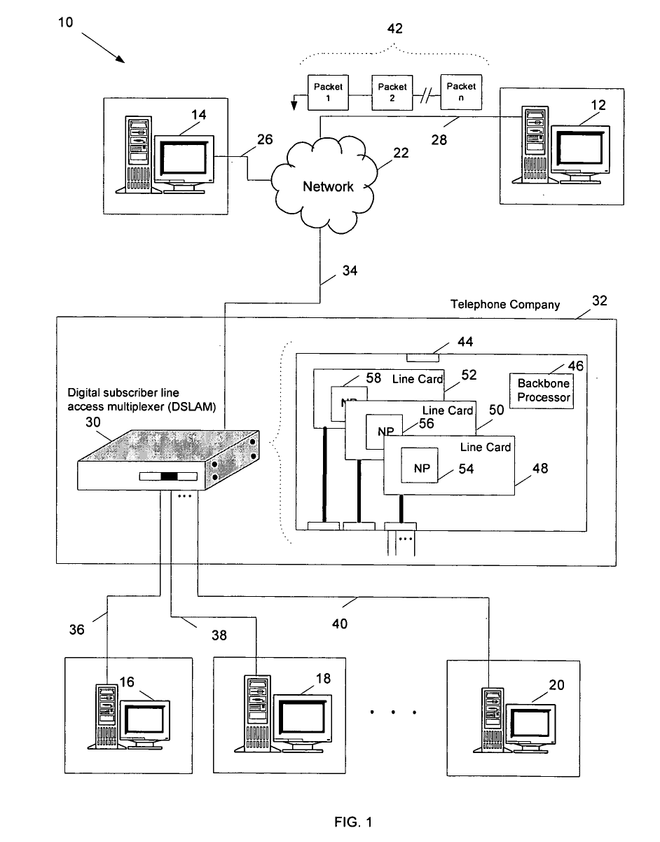

Referring to FIG. 1, a system 10 for transmitting packets among computer systems 12, 14, 16, 18, 20 includes a network 22 (e.g. a local area network (LAN), a wide area network (WAN), Internet, etc.) that is in communication with each of the computer systems. In this example, each of the computer systems is located at remote locations (e.g., a home, small business, etc.). Additionally, while computer systems 12 and 14 use e.g. 100 Mbit Ethernet connections 26, 28 for communicating with the network 22, computer systems 16, 18, and 20 communicate with the network through a digital subscriber line access multiplexer (DSLAM) 30. In this example the DSLAM 30 is remotely located e.g. at a telephone company central office 32.

The DSLAM 30 provides a relatively high-bandwidth connection 34 to the network 22 for the computer systems 16, 18, and 20, which are typically connected to the DSLAM from the individual homes or small businesses with “plain old telephone service” (POTS) subscriber lines 36, 38, 40 (e.g., copper telephone line). By subscribing for a digital subscriber line (DSL) with the telephone company 32, each customer is provided high-bandwidth transmission capabilities to and from each respective computer system 16, 18, 20 for relatively fast data and file transfers.

Dependent upon the distance between each computer system 16, 18, 20 location and the telephone company 32, along with the type of DSL service (e.g., asymmetric DSL (ADSL), High bit-rate DSL (HDSL), etc.) provided by the telephone company 32, relatively high bit rates (e.g., multiple megabits per second) are achieved for bridging the computer systems 16, 18, and 20 to the network 22.

In this example, computer system 12 transmits a series of “n” packets 42 through the network 22 into a connector 44 included in the DSLAM 30 for delivering the packets to their intended destination(s) (e.g., computer system 16, 18, or 20, etc.). The DSLAM 30 also includes a backbone processor 46 that manages e.g., three line cards 48, 50, 52 that bridge the connected computer systems to the network 22. For example, line card 48 communicates to the computer systems 16, 18, and 20, along with other computer systems (not shown). In this arrangement each line card 48 can communicate with as many as twenty-four computer systems subscribing to the DSL service provided by the telephone company 32. However, in other arrangements, each line card communicates with more than or less than twenty-four computer systems.

Each respective line card 48, 50, 52 includes a network processor 54, 56, 58 that processes a portion of the packets received by the DSLAM 30 along with other information. In this arrangement each network processor 54, 56, 58 is depicted to include the features of an Intel® Internet eXchange network processor (1×P) such as the Intel 1×P425. However, one or more of the network processors could incorporate other network processor designs. Network processors 54, 56, and 58 implement a fast path design that supports, at some packet sizes, a transmission rate of e.g., 52 Mbits/sec. from the the DSLAM 30 to the computer systems 16, 18, 20 and a transmission rate of e.g., 100 Mbits/sec. between the DSLAM and the network 22. In this particular example, DSLAM 30 uses the network processor 54 in bridging the computer systems 16, 18, 20 and the network 22. However, in other arrangements a router, hub, switch (e.g., an Ethernet switch), or other similar network-forwarding device that includes a network processor is used for delivering packets.

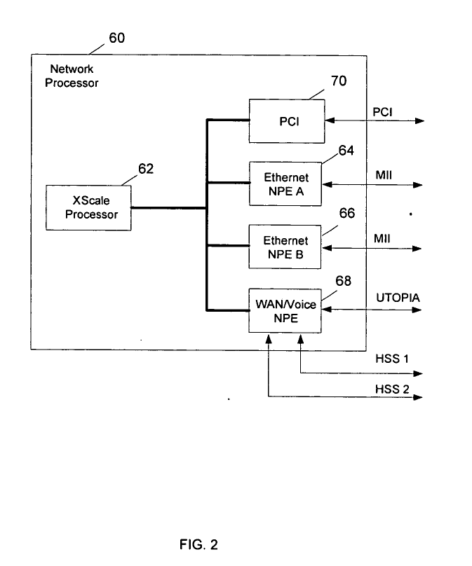

Referring to FIG. 2, the exemplary network processor 60 includes a core processor 62 (e.g., an Intel® XScale core processor) that performs “control plane” tasks and management tasks (e.g., look-up table maintenance, etc.). The network processor 60 also includes three network processor engines (NPE) 64, 66, 68 that perform certain “data plane” tasks. Each NPE is a hardware multi-threaded processor engine with separate instruction and data memory spaces that allow relatively quick local accessing of code and data. The NPEs 64, 66, 68 complement the XScale processor 62 for many computationally-intensive data plane operations such as packet header inspection and modification, packet filtering, packet error checking, checksum computation, and flag insertion and removal. By performing these packet-handling tasks, the NPEs 64, 66, 68 allow the XScale processor 62 to efficiently execute other “data plane” processes such as digital signal processing (DSP) functions (e.g., digital voice processing) and “control plane” processes.

The combination of these four processors 62, 64, 66, 68 provides relatively quick data transferring among the processors along with relatively fast instruction execution. Many of the architectural features provided by the XScale processor 62 (e.g., caching) reduce memory latency by hardware multi-threading, independent instruction and data memory spaces, and parallel processing by the XScale processor 62 and the three NPEs 64, 66, 68.

In this particular example, along with off-loading the execution of processes such as cryptography algorithms (e.g., SHA-1, DES, 3DES, etc.) from the XScale processor 62, NPE 64 and NPE 66 each connect to Media Independent Interfaces (MII) to provide relatively fast Ethernet data transfer rates with network devices or other interfaces. For example, the MIIs can pass packets with an Ethernet switch, the physical (PHY) layer of a fiber-through-the-home (FTTH) interface, or other types of fast Ethernet media. In this particular example, the MII's are used to connect the DSLAM to the network 22.

Similar to NPE 64 and 66, NPE 68 also off-loads the execution of processes from the XScale processor 62 for applications e.g., associated with voice-over-internet protocol (VoIP) and subscriber line interface circuitry (SLIC). The NPE 68 provides data transmission through a universal test and operations physical layer interface for ATM (Utopia). The Utopia interface is typically an 8-bit data path with up to five address lines for both transmitting and receiving data. Additionally, in this example the NPE 68 provides two high-speed serial (HSS) ports that enable the NPE to communicate in a serial fashion using time division multiplexing (TDM) to send multiple data streams over a single signal line while supporting data stream protocols such as T1, E1, GCI, and MVIP. In one exemplary application, either of the HSS ports can be used to pass voice content to coder/decoder (CODEC) circuitry for delivery to a telephone system.

The network processor 60 also includes a peripheral component interconnect (PCI) 70 that provides a 32-bit data interface that operates e.g., up to 66 MHz and is typically used to connect to multiple devices (e.g., a general purpose processor, another network processor, etc.) external to the network processor without additional circuitry. In some arrangements PCI 70 includes two direct memory access (DMA) engines for transferring data and for off-loading such operations from the XScale processor 62.

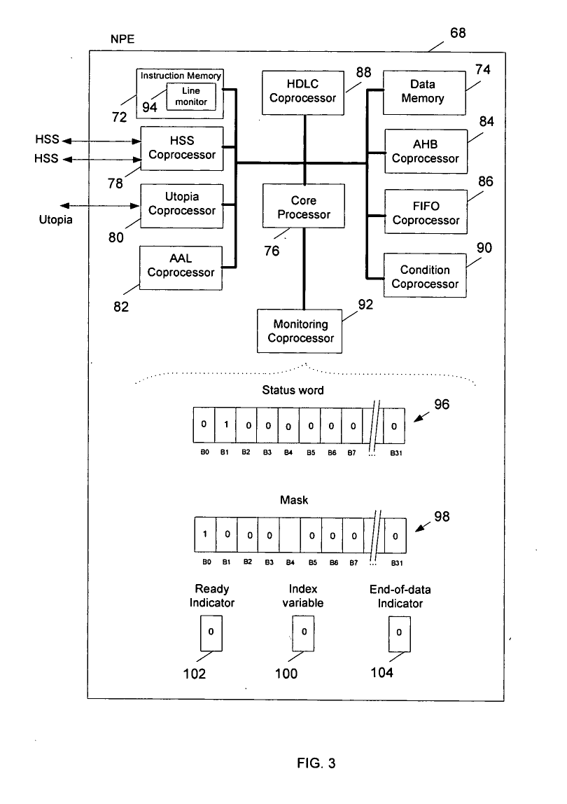

Referring to FIG. 3, along with instruction memory 72 for storing on or more processes to be executed, the NPE 68 includes memory 74 for storing data such as packets and other types of data. The NPE 68 includes a core processor 76 that executes instructions stored in the instruction memory 72 and manages the operations of eight coprocessors included in NPE 68 and that are known as accelerators. By off-loading processing from core processor 76 onto the eight coprocessors and executing instructions in parallel, process execution by NPE 68 is improved.

In this particular example NPE 68 includes an HSS coprocessor 78 that provides a dedicated accelerator for executing operations associated with data transmission and reception over the two HSS ports. Similarly, the NPE 68 includes a coprocessor 80 for managing data transmission over a Utopia interface. To prepare packet data (e.g., cells) for transmission over an asynchronous transfer mode (ATM) network, an ATM adaptation layer (AAL) coprocessor 82 is included in the NPE 68. The AAL coprocessor 82 assists in the execution of ATM layer services such as user services, control services, and management services. For example, the AAL coprocessor 82 executes processes for converting information from higher protocol layers into 48 byte lengths so that a header (e.g., 5 byte header) can be added to produce a 53 byte cell, which is the typical data packet size transmitted over an ATM network.

The NPE 68 also includes an advanced microprocessor bus architecture (AMBA) high-speed bus (AHB) coprocessor 84. The AHB coprocessor 84 executes processes associated with multi-level busing systems, and provides standard bus protocols for connecting on-chip IP, custom logic, and specialized functions. Typically the AHB coprocessor 84 supports e.g., 32, 64, and 128-bit data-bus implementations with a 32-bit address bus, as well as smaller byte and half-word designs.

While this exemplary NPE 68 includes eight coprocessors, typically the NPE 68 is capable of including at least sixteen coprocessors. In this example, the NPE 68 also includes a “first-in, first-out” (FIFO) coprocessor 86 that executes processes for handling requests and other operations associated with queues and stacks included in the NPE.

The NPE 68 network processor engine also includes a high-level data link control (HDLC) coprocessor 88 that executes processes associated with switched and non-switched protocols that are typically bit-wise oriented. A condition coprocessor 90 manages and executes processes associated with condition codes such as carry over, under flow, and other indicators.

Since each of the coprocessors 78-90 are implemented in hardware and execute in parallel, the processing capabilities of the NPE 68 are relatively faster while also conserving the processing capacity of the core processor 76 due to process execution off-loading. Also, by implementing parallel processing with the coprocessors 78-90, clock cycles are conserved. Additionally, since the NPE 68 provides the capability of suspending the execution of processes as other operations are executed (e.g., memory accessing), clock cycles are further conserved.

The NPE 68 also includes a monitoring coprocessor 92 for monitoring the subscriber lines 36, 38, and 40 along with the other DSL subscriber lines (e.g., total of twenty-four lines) in communication with the line card 48. In some arrangements, the coprocessor 92 monitors each of the twenty-four subscriber lines to determine if one or more of the lines is ready for servicing (e.g., a subscriber line is ready to transmit packets to the DSLAM, receive packets, etc.). However, in other arrangements the monitoring processor 92 monitors other operations associated with NPE 68 such as monitoring error bits, interrupt sources, and other types of bit-mapped information that is typically represented with binary logic levels (e.g., logic level “1” and “0”).

To monitor the subscriber lines 36, 38, 40 for servicing, a line monitor 94, which is stored in the instruction memory 72, is executed on the monitoring coprocessor 92. Although, in some arrangements the line monitor 94 is stored in the monitoring coprocessor 92 or on a storage device (e.g., a hard drive, CD-ROM, etc.) in communication with the DSLAM 30. Furthermore, in some arrangements the line monitor 94 is executed on one or more of the other coprocessors 78-90 or on the core processor 76.

The line monitor 94, monitors each of the subscriber lines, by respectively assigning a bit included in e.g., a 32-bit word referred to as status word 96, to each of the subscriber lines. Typically, information that represents if one or more of the subscriber lines are ready for servicing is provided to the monitoring coprocessor by another portion of the NPE 68 (e.g., another coprocessor) or externally from the NPE (e.g., from the line card 48). In some arrangements the status word 96 is stored in a variable that is accessible by the monitoring coprocessor 92, however, in other arrangements the status word is stored in a register or other storage device associated with the monitoring coprocessor.

In this example status word 96 bit B0 is assigned to subscriber line 36 and the line monitor 94 continues assigning status word bits to the subscriber lines with one-to-one mapping and concludes with bit B24 (not shown) being assigned to subscriber line 40, which represents the twenty-fourth subscriber line in communication with line card 48. While this example uses a one-to-one mapping scheme, in other arrangements other mapping schemes are used for assigning the bits included in the status word 96.

In this example, if a particular status word bit (e.g., bit B1) is storing a logic level “1”, the corresponding subscriber line (e.g., line 38) is ready to be serviced (e.g., ready for transmitting packets to the line card, ready for receiving packets from the line card, etc.). Accordingly, a bit storing a logic level “0” represents that the associated subscriber line is not ready for servicing, however, the states that the logic levels represent are reversible.

To determine the status of each individual subscriber line from the appropriate status word 96 bit, the monitoring coprocessor 92 uses a mask 98 to extract the logic level stored in the particular status word bit. However, the mask 98 is also capable of extracting the logic level stored in more than one bit to determine the status of two or more subscriber lines. In this example, a logical “AND” operation is applied to the mask 98 and the status word 96 to extract the logic level stored in one status word bit. In this particular example, bit B1 stores a logic level “1” to represent that subscriber line 38 is ready for servicing and the status word bits B0 and B2-B23, some of which are not shown, store logic level “0” to represent that the associated subscriber lines (i.e., line 36, . . . , line 40) are not ready for servicing. Additionally, since only twenty-four status word 96 bits are needed for representing the readiness state of the twenty-four subscriber lines, the remaining status word bits (e.g., bits B24-B31) store a logic level “0” and do not represent subscriber lines.

Typically, the line monitor 94 changes the binary content of the mask 98 to check the binary content of each of the twenty-four bits (i.e., bits B0-B23) included in the status word 96. In one arrangement, the line monitor 94 checks each of the twenty-four bits in a round-robin fashion so that bit checking is performed in a cyclical fashion and repeats (e.g., check B0, check B1, . . . , check bit B24, check bit B0, etc.). However, in some arrangements, other schemes such as a weighted round robin provides the checking methodology. In this example, only mask 98 bit B0 currently stores a logic level “1” so that status word 96 bit B0 is checked by applying the mask to the status word with a logical “AND” operation.

As the mask 98 is applied to the status word 96, the line monitor 94 tracks which status bit is being checked by using an index variable 100. In this example, the status word bit B0 is being checked with the mask 98 since a logic level “1” is stored in mask bit B0. Accordingly, the index variable 100 stores the integer “0” to indicate that the first status word bit, which corresponds to subscriber line 36, is being checked.

Additionally, the monitoring coprocessor 92 uses an indicator 102 to indicate whether the status word 96 bit being checked is ready for servicing. In this example, the line monitor 94 stores a logic level “0” in the ready indicator 102 to represent that the subscriber line being checked is not ready for servicing. Furthermore, after the line monitor 94 completes one round robin cycle to check each status word 96 bit associated with a subscriber line, the line monitor uses an end-of-data indicator 104 to notify NPE 68 that one cycle has been completed. Here, a logic level “1” is stored in the end-of-data indicator 104 to indicate a completed cycle. In some arrangements, after a logic level “1” is stored in the end-of-data indicator 104, the line monitor 94 waits for the subscriber lines 36, 38, 40, etc. to be re-checked by the DSLAM 30 for service readiness and the arrival of another set of data that represents the readiness of the subscriber lines before performing another round robin cycle.

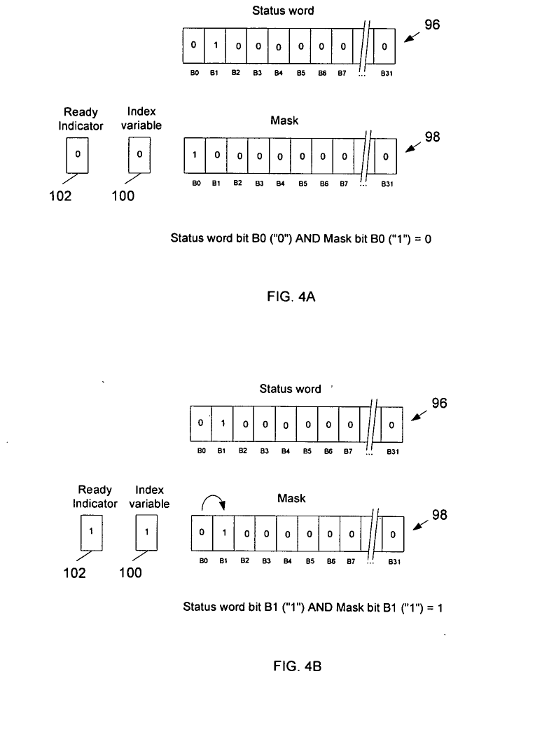

Referring to FIG. 4A the logic levels stored by the status word 96 represent that the subscriber line (e.g., line 38) associated with bit B1 is ready for servicing and the other twenty-three subscriber lines are not. In this example the mask 98 is extracting the logic level of the status word bit B0 to initiate a round robin cycle to check each status word bit. To extract this logic level, the line monitor 94 stores a logic level “1” in mask bit B0 and logic level “0” in the other mask bits B1-B31. The line monitor 72 applies a logical “AND” operation to the status word 96 and the mask 98 and in some arrangements stores the operation's result in another word, register, or other destination. Since the logic level of status word bit B0 is being extracted, the line monitor 94 stores the integer “0” in the index variable 100. Additionally, since the extracted value of status word B0 is logic level “0”, which represents that subscriber line 36 is not ready for servicing, the line monitor 94 stores a logic level “0” in the ready indicator 102.

Referring to FIG. 4B, after checking whether subscriber line 36 is ready for servicing, by extracting the logic level stored in status word bit B0, the line monitor 94 continues the round robin cycle by checking status word 96 bit B1, which is associated with subscriber line 38. To check status word bit B1, the executed line monitor 94 stores a logic level “1” in the mask bit B1 and logic level “0” in the other mask bits (i.e., B0, B2-B31) to mask the bits not currently of interest. Again, a logical “AND” operation is applied to the status word 96 and the mask 98 to extract the logic level stored in status word bit B1. In this example, since the status word bit B1 stores a logic level “1”, the “AND” operation's result is a logic level “1” that indicates subscriber line 38 is ready for servicing. The line monitor 94 also increments the value stored in index variable 100 to “1” to indicate that status word bit 1 is being checked. Additionally, since applying the logical “AND” operation produces a logic level “1” (i.e., status word bit B1=“1” AND mask bit B1=“1”=“1”), which indicates subscriber line 38 is ready for servicing, the line monitor 94 sets the ready indicator 102 for a logic level “1” to indicate that subscriber line 38 is ready for servicing.

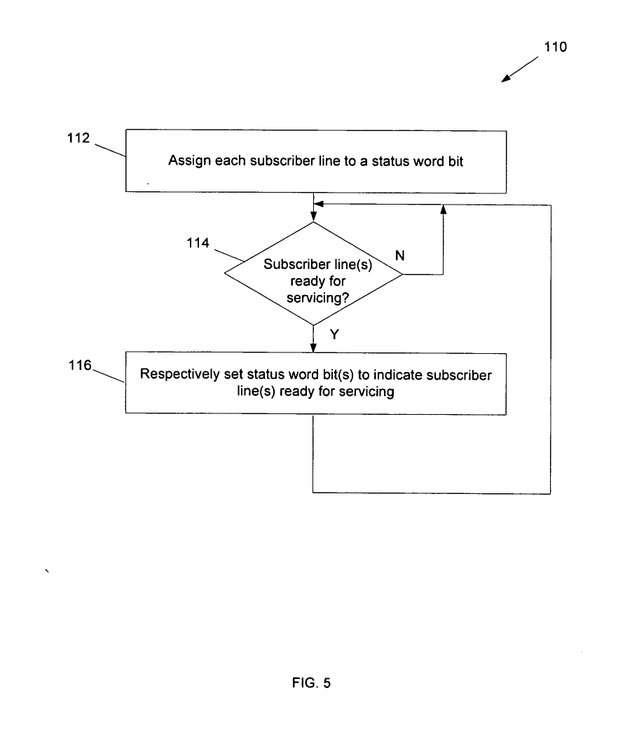

Referring to FIG. 5 an example of a portion of a line monitor 110 assigns 112 each subscriber line associated with a line card (e.g., line card 48) to a bit included in a status word such as status word 96. The line monitor 110 determines 114 if one or more of the subscriber lines is ready for servicing. In some arrangements, the subscriber lines individually send a message to request servicing that is detected by the DSLAM 30 or a line card (e.g., line card 48) and each request is provided to the NPE 68 so that the readiness state of each of the subscriber line can be entered into a status word by the line monitor 110.

If none of the subscriber lines are ready for servicing, the line monitor 110 returns to wait for one or more of the lines to become ready for servicing. If one or more of the subscriber lines are ready for servicing, the line monitor 110 sets 116 the appropriate one or more bits in a status word to indicate which of the lines are ready for servicing. After setting the bits, the line manager 110 returns to repeat the determination if one or more of the subscriber lines are ready for servicing.

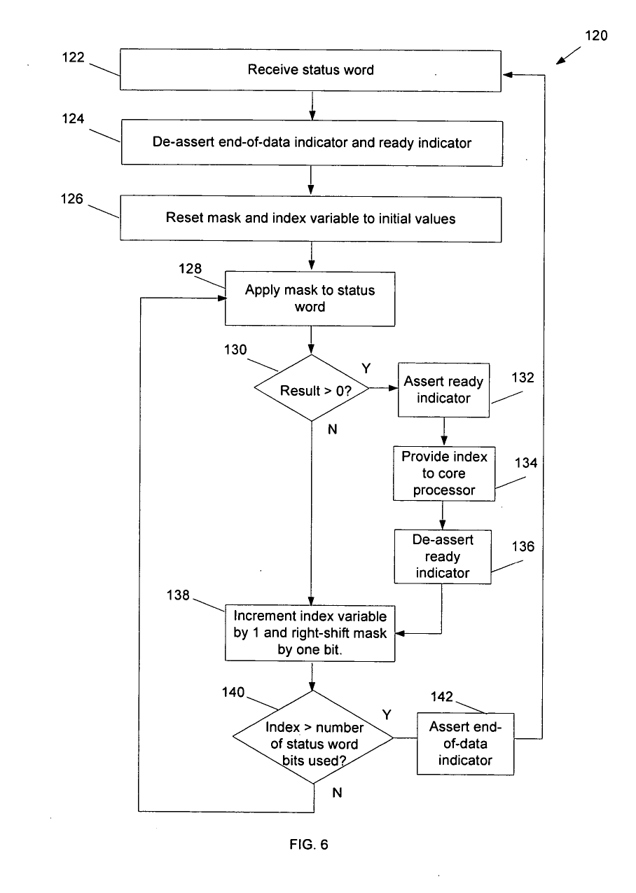

Referring to FIG. 6, an example of a portion of a line monitor 120 executed on a NPE coprocessor such as the monitoring coprocessor 92 receives 122 a status word that includes binary data that represents subscriber line readiness or some other information mapped into the status word bits (e.g., error detection, interrupt sources, etc.).

After receiving the status word, the line monitor 120 de-asserts 124 a ready indicator, such as ready indicator 102, and an end-of-data indicator, such as end-of-data indicator 104, both of which may be active from a previous execution of the line monitor. The line manager 120 also resets 126 a mask (e.g., mask 98) and an index variable (e.g., index variable 100) to their respective initial values. For example, the mask is reset 126 to a binary value (e.g., 100 . . . 00) for extracting the logic level stored in status word bit B0 that provides the service readiness state of the first subscriber line (e.g., subscriber line 36). Furthermore, in some arrangements, the index variable is reset to decimal integer “0” to indicate using base 0 that the first subscriber line (e.g., subscriber line 36) is being checked.

After resetting the mask and the index variable, the line monitor 120 applies 128 the mask to the status word. Typically a logical “AND” operation is performed on the mask and the status word to extract the logic level stored in the appropriate status word bit (e.g., bit B0). After applying the mask, the line monitor 120 determines 130 if the result of the logical “AND” operation is greater than zero. If the result is greater than zero, the subscriber line being checked is ready for servicing and the line monitor 120 asserts 132 the ready indicator (e.g., stores a logic “1” in the ready indicator). Along with asserting 132 the ready indicator, the line manager 120 also provides 134 the index variable to the core processor 76 so that the NPE 68 is aware which subscriber line is ready for servicing. After providing 134 the index, the line monitor 120 de-asserts 136 the ready indicator.

After de-asserting the ready indicator or if applying the mask does not produce a greater than zero result, the line monitor 120 increments 138 the index variable by 1 and right-shifts the mask by one bit. By respectively incrementing and right-shifting, the index variable and the mask are prepared for extracting the logic level stored in the next status word bit. However, in some arrangements, the mask is left-shifted due to the orientation of the bits in the status word. After incrementing and right-shifting, the line monitor 120 determines 140 if the value stored in the index variable is larger than the number of status word bits being used to represent the readiness status of the subscriber lines. For example, in this instance twenty-four bits of the thirty-two-bit status word 96 are used to represent the twenty-four subscriber lines associated with the line card 48. In other arrangements all of the status word bits (e.g., thirty-two) are used and the line monitor 120 determines if the value stored in the index variable is larger than the length of the status word.

If the value stored in the index variable is larger than the number of status word bits used, the line monitor 120 asserts 142 an end-of-data indicator to notify the core processor 76 that the monitoring coprocessor 92 has checked each bit in the status word and then returns to receive another status word. If the index variable is not larger than the number of status word bits being used, the line monitor 120 returns to apply the right-shifted mask to the status word to extract the logic level stored in the next status word bit for checking if the next subscriber line is ready for servicing.

Particular embodiments have been described, however other embodiments are within the scope of the following claims. For example, the operations of the line monitor 94 can be performed in a different order and still achieve desirable results.

1. A method comprising:
monitoring a bit in a coprocessor included in a packet engine that represents an operation associated with a packet processor that includes the packet engine; and
providing the packet engine the status of the bit.

2. The method of claim 1 wherein monitoring the bit includes maintaining an indicator representing the status of the bit.

3. The method of claim 1 wherein monitoring the bit includes maintaining an index identifying the bit.

4. The method of claim 1 wherein monitoring the bit includes maintaining an indicator representing completion of monitoring of the bit.

5. The method of claim 1 wherein monitoring the bit includes applying a logical mask to the bit.

6. The method of claim 1 wherein the bit represents servicing status of a digital subscriber line.

7. The method of claim 1 wherein the bit is a portion of a word.

8. A computer program product, tangibly embodied in an information carrier, the computer program product being operable to cause a machine to:
monitor a bit in a coprocessor included in a packet engine that represents an operation associated with a packet processor that includes the packet engine; and
provide the packet engine the status of the bit.

9. The computer program product of claim 8 wherein monitoring the bit includes maintaining an indicator representing the status of the bit.

10. The computer program product of claim 8 wherein monitoring the bit includes maintaining an index identifying the bit.

11. The computer program product of claim 8 monitoring the bit includes maintaining an indicator representing completion of monitoring of the bit.

12. The computer program product of claim 8 wherein monitoring the bit includes applying a logical mask to the bit.

13. The computer program product of claim 8 wherein the bit represents servicing status of a digital subscriber line.

14. The computer program product of claim 8 wherein the bit is a portion of a word.

15. A line monitor comprises:
a process to monitor a bit in a coprocessor included in a packet engine that represents an operation associated with a packet processor that includes the packet engine; and
a process to provide the packet engine the status of the bit.

16. The line monitor of claim 15 wherein monitoring the bit includes maintaining an indicator representing the status of the bit.

17. The line monitor of claim 15 wherein monitoring the bit includes maintaining an index identifying the bit.

18. The line monitor of claim 15 wherein monitoring the bit includes maintaining an indicator representing completion of monitoring of the bit.

19. The line monitor of claim 15 wherein monitoring the bit includes applying a logical mask to the bit.

20. The line monitor of claim 15 wherein the bit represents servicing status of a digital subscriber line.

21. The line monitor of claim 15 wherein the bit is a portion of a word.

22. A system comprising:
a coprocessor included in a packet engine that is capable of,
monitoring a bit representing an operation associated with a packet processor that includes the packet engine; and
providing the packet engine the status of the bit.

23. The system of claim 22 wherein monitoring the bit includes maintaining an indicator representing the status of the bit.

24. The system of claim 22 wherein monitoring the bit includes maintaining an index identifying the bit.

25. A packet forwarding device comprising:
an input port for receiving packets;
an output for delivering the received packets; and
a coprocessor included in a packet engine that is capable of,
monitoring a bit representing an operation associated with a packet processor that includes the packet engine, and
providing the packet engine the status of the bit.

26. The packet forwarding device of claim 25 wherein monitoring the bit includes maintaining an indicator representing the status of the bit.

27. The packet forwarding device of claim 25 wherein monitoring the bit includes maintaining an index identifying the bit.

28. A method comprising:
monitoring a bit in a monitoring coprocessor included in a network processing engine that represents the servicing availability of a digital subscriber line associated with a network processor that includes the network processing engine; and
providing the network processing engine data representing the servicing availability of the digital subscriber line.

29. The method of claim 28 wherein monitoring the bit includes maintaining an indicator representing that the digital subscriber line is ready for servicing.

30. The method of claim 28 monitoring the bit includes maintaining an index variable that stores an integer identifying the digital subscriber line ready for servicing.
